(19) United States
(12) Patent Application Publication
(10) Pub. No.: US 2010/0326302 A1
(43) Pub. Date: Dec. 30, 2010

(54) PRINTING CYLINDER OR PRINTING CYLINDER SLEEVE AND METHOD FOR PRODUCING IT

(75) Inventor: Michiel Van der Meulen, Arnhem (NL)

Correspondence Address: VENABLE LLP, P.O. BOX 34385, WASHINGTON, DC, 20043-9998, US

(73) Assignee: Mueller Martini Druckmaschinen GmbH, Maulburg (DE)

(21) Appl. No.: 12/824,676

(22) Filed: Jun. 28, 2010

(30) Foreign Application Priority Data
Jun. 29, 2009 (NL) 2003101

(51) Int. Cl. B41C 3/08; B32B 37/12; B29C 37/00; B22D 45/00

(52) U.S. Cl. 101/401.1; 156/60; 264/138; 164/69.1

(57) ABSTRACT

A method for producing a printing cylinder or a printing cylinder sleeve includes providing a plurality of cylindrical discs with an essentially cylindrical outside surface and respectively one central opening for positioning the cylindrical discs around a core, and machining the essentially cylindrical outside surfaces so that the cylindrical discs form a printing cylinder surface when mounted on the core. Prior to positioning the cylindrical discs around the core, the method includes machining at least one of the cylindrical discs to form at least one contact surface. The contact surface is machined precisely so that during the installation of the respective cylindrical disc around the core, the contact surface comes to rest parallel against a complementary formed surface of an adjacent element of the printing cylinder or printing cylinder sleeve. The method further includes positioning the cylindrical discs around the core and alternately joining the cylindrical discs.

### CROSS-REFERENCE TO RELATED APPLICATION

This application claims the priority of the Dutch Patent Application No. 2003101, filed on Jun. 29, 2009, the subject matter of which is incorporated herein by reference.

### BACKGROUND OF THE INVENTION

The invention relates to a method for producing a printing cylinder or a printing cylinder sleeve.

European patent document No. EP 1 127 953 discloses a method for producing a printing cylinder sleeve, provided on a mandrel inside a printing press, in order to form a printing cylinder. A round aluminum disc is reshaped into a shell with the aid of a number of operational steps. A central opening is worked into the disc and, starting with the central opening, cutouts are inserted in the radial direction. The edge sections of the disc, located between the cutouts, are reshaped in the axial direction to form tongues. One outside edge of the disc is reshaped through axially effective forces into a cylinder-shaped surface, thereby creating an open shell. Some of the shells are arranged successively on a hollow, cylindrical core, wherein the tongues project outward from the hollow, cylindrical core. In the process, the shells are pushed toward each other and in part one inside the other, and are glued together with an epoxy resin.

The disclosed method has the disadvantage that the resulting printing cylinder neck in some cases produces printing results that are not sufficiently precise, which can result in one or more of the following effects. During the production, it is difficult to realize the bending toward the outside of the tongues with sufficient precision, thus causing the shells to be arranged eccentric on the hollow, cylinder-shaped core. The tongues furthermore cause springiness in the printing cylinder sleeve during the operation, relative to the mandrel which is insufficiently defined and adds to an inherent springiness (for a better determination) of the hollow cylindrical core. A further source of inaccuracy is the difficulty in deforming the shells at relatively high, alternating pressure forces, for example encountered during the offset printing and the gravure printing as a result of the relatively thin shell walls.

### SUMMARY

It is therefore an object of the present invention to provide a method for solving at least one of the aforementioned problems, or at least provide an alternative. In particular, it is an object of the invention to provide a method which results in producing printing cylinders or printing cylinder sleeves that operate with precision.

The above and other objects are accomplished according to one aspect of the invention where there is provided a method for producing a printing cylinder or a printing cylinder sleeve, which, in one embodiment includes providing a plurality of cylindrical discs with an essentially cylindrical outside surface and respectively one central opening for positioning the cylindrical discs around a core; machining the essentially cylindrical outside surfaces so that the cylindrical discs form a printing cylinder surface when mounted on the core; prior to positioning the cylindrical discs around the core, machining at least one of the cylindrical discs to form at least one contact surface, wherein the at least one contact surface is machined precisely so that during the installation of the respective cylindrical disc around the core, the at least one contact surface comes to rest parallel against a complementary formed surface of an adjacent element of the printing cylinder or printing cylinder sleeve; positioning the cylindrical discs around the core; and alternately joining the cylindrical discs.

According to the above-mentioned embodiment, by machining the at least one contact surface with such precision that during the installation of the respective cylindrical disc around a core, the at least one contact surface comes to rest parallel against a complementary formed surface of an adjoining element of the printing cylinder or the printing cylinder sleeve, it may be possible to use a thicker material as compared to the material used for the press-formed disc disclosed in European patent document No. EP-1 127 953. Owing to the machining step, it may also be possible to select a cylindrical disc having a shape that differs from the shape disclosed in the European patent document No. EP-1 127 953 and/or a cylindrical disc which may be produced with a different method than the press-forming. Each of these effects by themselves or in a combination thereof may result in producing a printing cylinder or a printing cylinder sleeve with a higher precision.

According to another embodiment, the step of machining at least one of the cylindrical discs to form at least one contact surface may involve the machining of a first gluing surface on a first axial end of at least one cylindrical disc. A gluing surface on the first axial end may allow gluing the at least one cylindrical disc precisely to a following cylindrical disc.

According to a further embodiment, the step of machining at least one of the cylindrical discs to form at least one contact surface may involve the machining of a different gluing surface on a second axial end of a following cylindrical disc. During the alternating joining of the cylindrical discs, glue may be furthermore applied to the first and/or the following gluing surface and the first and the following gluing surface may be placed parallel and facing against each other. As a result of the machining of both gluing surfaces, it may be easy to precisely match the shape of both gluing surfaces, to create a good glue bond.

According to one embodiment, the step of machining at least one of the cylindrical discs to form at least one contact surface may involve the machining of a second gluing surface on the second axial end of the same at least one cylindrical disc. A cylindrical disc may thus be formed which can precisely adjoin at both ends a following cylindrical disc.

According to another embodiment, the step of machining at least one of the cylindrical discs to form a contact surface may involve the machining of a plurality of cylindrical discs to form a gluing surface only on one axial end of the cylindrical disc, where this at least one cylindrical disc may be provided on one axial end of the printing cylinder or the printing cylinder sleeve. Thus, the cylindrical disc, as well as the cylindrical disc positioned in-between for the finished printing cylinder or the printing cylinder sleeve, can be produced from one mold, as well as one or two of the end discs at the axial ends of the finished printing cylinder or printing cylinder sleeve. As compared to the disclosed methods, this may save cost and time, where the end discs are produced from a different basic mold than the discs positioned in-between.

According to a further embodiment, the method may include providing a stop edge in the central opening of at least one cylindrical disc, where the machining of at least one of the cylindrical discs prior to the forming of at least one contact surface may involve the machining of a central surface on the radial insides of the stop edge and where during the installation of the cylindrical discs around the core, the central surface may come to rest without play against the core. A stop edge with a precisely machined central surface may ensure that at least one cylindrical disc is centered precisely, relative to the core. An eccentric positioning of the cylindrical disc, relative to the core, may thus be avoided during the gluing and/or during use. For example, the core itself can be delivered with a sufficiently precisely formed radial outside surface, or may be provided during the machining step with a radial outside surface that precisely coincides with that of the central surface.

According to one embodiment, at least one cylindrical disc comprises a core gluing surface which may be provided in the central opening and may be delimited on a first axial end by the stop edge, where the core gluing surface may be arranged to point radially outward, relative to the central surface, thus allowing the use of a filling glue. The combination of the stop edge with the central surface and the core gluing surface may ensure that the glue can be spread uniformly across the core gluing surface.

According to a further embodiment, the core gluing surface may be provided on a second axial end of an glue-running surface which may face away from a first axial end and may extend radially outward and axially toward the outside of the cylinder-shaped core gluing surface, where filling glue may be applied to the core. At least one cylindrical disc may be pushed across the filling glue applied to the core, to take up the filling glue and accommodate it in a space defined by the core gluing surface, the stop edge and the core, thus ensuring that the filling glue may be distributed sufficiently over the core gluing surface, even if the core gluing surface is relatively large.

According to a further embodiment, the cylindrical outside surface may be positioned eccentric, relative to the central axis, may have a non-round shape and/or can be embodied hook-shaped. Thanks to the step of processing the essentially cylindrical outside surface to form a printing cylinder surface, a cylindrical outside surface may be formed which has a sufficiently precise cylindrical shape to function as printing cylinder surface. This processing step comprises, for example, the removal by turning of the complete, essentially cylindrical outside surface following the installation of the cylindrical discs around the core and the alternate joining of the cylindrical discs. Alternatively, or in addition to this surface removal, the essentially cylindrical outside surfaces may be provided with a cylinder-shaped cover layer.

According to one embodiment, the processing of the essentially cylindrical outside surfaces for forming a printing cylinder surface may involve providing a gap in the axial direction in the printing cylinder surface, where the gap is intended to accommodate edges of a printing plate or a rubber printing plate. The inventive method thus may make it possible to form the cylindrical disc from a material with a thicker wall than the material according to the disclosed method for producing press-formed discs. As a result, it may be easier to insert a gap into the printing cylinder surface, for example through milling or cutting, without leaving an open connection between an inside space of the printing cylinder or the printing cylinder sleeve and the outside.

The invention may furthermore relate to a printing cylinder or a printing cylinder sleeve which may be produced with the aid of the inventive method, as defined in one of the independent claims.

### BRIEF DESCRIPTION OF THE DRAWINGS

The present invention may be more readily understood from the following detailed description when read in conjunction with the accompanying drawings, in which:

FIG. 1 is perspective view of a cylindrical disc, according to an embodiment of the invention;

FIG. 2 is a view of the cylindrical disc according to FIG. 1, as seen in the axial direction;

FIG. 3 is a sectional representation along the line III-III in FIG. 2;

FIG. 4 is a perspective view of an intermediate disc, according to an embodiment of the invention;

FIG. 5 is a view of the intermediate disc according to FIG. 4, as seen in the axial direction;

FIG. 6 is a sectional representation along the lines VI-VI in FIG. 5;

FIG. 7 is a detail VII from FIG. 6;

FIG. 8 is a perspective representation of a starting disc, according to an embodiment of the invention;

FIG. 9 is a view of the starting disc according to FIG. 8, as seen in the axial direction;

FIG. 10 is a sectional representation along the line X-X in FIG. 9;

FIG. 11 is a detail XI from FIG. 10;

FIG. 12 is a perspective view of an end disc, according to an embodiment of the invention;

FIG. 13 is a view of the end disc according to FIG. 12, as seen in the axial direction;

FIG. 14 is a sectional representation along the line XIV-XIV in FIG. 13;

FIG. 15 is a detail XV from FIG. 14;

FIG. 16 is a printing cylinder sleeve, according to an embodiment of the invention;

FIG. 17 is a view of an operating side of the printing cylinder housing according to FIG. 16, as seen in the axial direction;

FIG. 18 is a view from the side of the printing cylinder sleeve according to FIG. 16;

FIG. 19 is a drive-side view of the printing cylinder sleeve according to FIG. 16, as seen in the axial direction;

FIG. 20 is a cross-section through a printing cylinder sleeve with alternatively formed discs, according to an embodiment of the invention;

FIG. 21 is a cross-sectional representation of a cylindrical disc with gluing base, according to an embodiment of the invention; and

FIG. 22 is an auxiliary tool for installing cylindrical discs, according to an embodiment of the invention.

### DETAILED DESCRIPTION

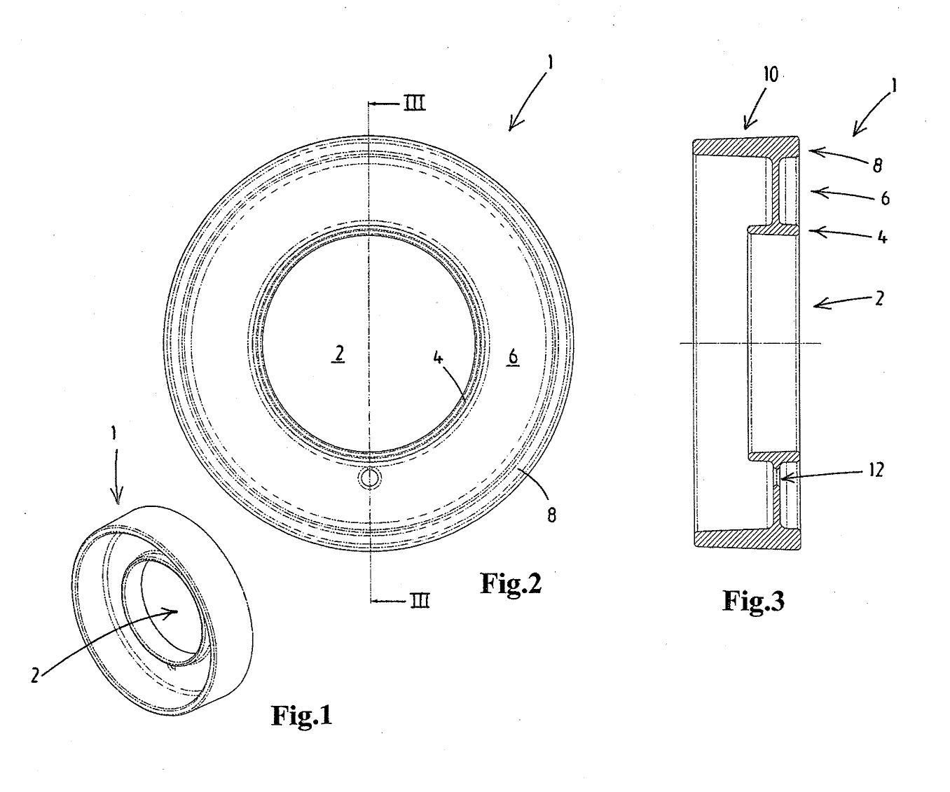

FIG. 1 shows a cylindrical disc according to an embodiment of the invention, which is on the whole given the reference number 1. For this embodiment, the cylindrical disc 1 is formed by pouring molten aluminum into a correspondingly shaped casting mold. The cylindrical disc 1 comprises a central opening 2, in this case a round opening, which is oriented concentric to a central axis which in this case is the axis of symmetry for the cylindrical disc. The cylindrical disc 1 furthermore comprises a cylindrical base 4 which is connected continuously to a ring-shaped wall part 6 which, in turn, is connected to a cylindrical outside wall 8. The cylindrical outside wall 8 comprises an essentially cylindrical outside surface 10. The expression “essentially cylindrical” in this case means that the outside surface does not have to be designed to be purely cylindrical around the axis of symmetry or around the central axis for the cylindrical disc 1. For this embodiment, the essentially cylindrical outside surface 10 has a slightly conical shape, where this shape permits an easier removal from the casting mold. The ring-shaped wall section 6 is provided with an air opening 12.

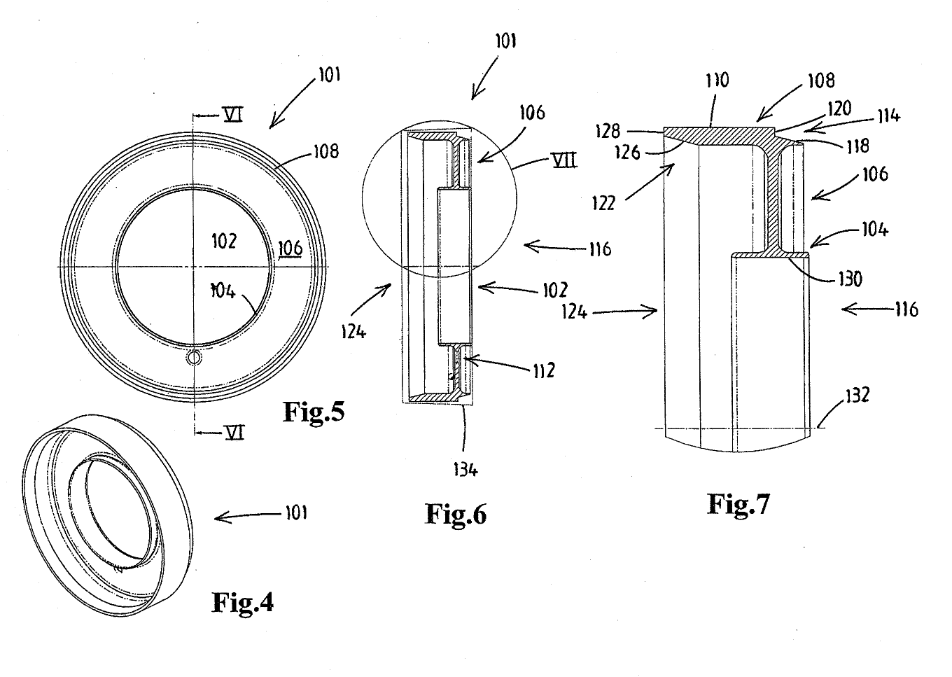

The cylindrical disc 1 can be machined at different locations, to form an intermediate disc, a starting disc or an end disc. FIGS. 4 to 7 show an intermediate disc 101 which is formed from a cylindrical disc and for this example from the cylindrical disc 1. The intermediate disc 101 comprises a central opening 102, a cylindrical base 104, a ring-shaped wall section 106 and an outside wall 108. The ring-shaped wall section 106 is provided with an air opening 112. The intermediate disc 101 is formed from the cylindrical disc 1 through machining, in this case through surface removal by turning of three contact surfaces. A first contact surface forms a first gluing surface 114 which is provided at a first axial end 116 of the intermediate disc 101. The first gluing surface 114 comprises a conical surface section 118 and a ring-shaped surface section 120. A second contact surface functions as a second gluing surface 122 which is provided on a second axial end 124 of the intermediate disc 101. The second gluing surface 122 comprises a conical wall section 126 and a ring-shaped wall section 128. The gluing surfaces 114 and 122 are embodied to complement each other.

A core gluing surface 130 functions as the third contact surface, where the core gluing surface 130 is formed cylinder-shaped around the central axis 132 of the intermediate disc 101 and is located in the central opening 102. The core gluing surface 130 at the same time forms a bottom edge of the cylindrical base 104. The essentially cylindrical outside surface 10 of the cylindrical disc 1 is furthermore re-shaped with the aid of machining into a cylindrical outside surface 110. FIG. 6 schematically shows the aluminum parts removed through machining by showing the contour of the non-machined cylindrical disc 1 with the dashed line 134.

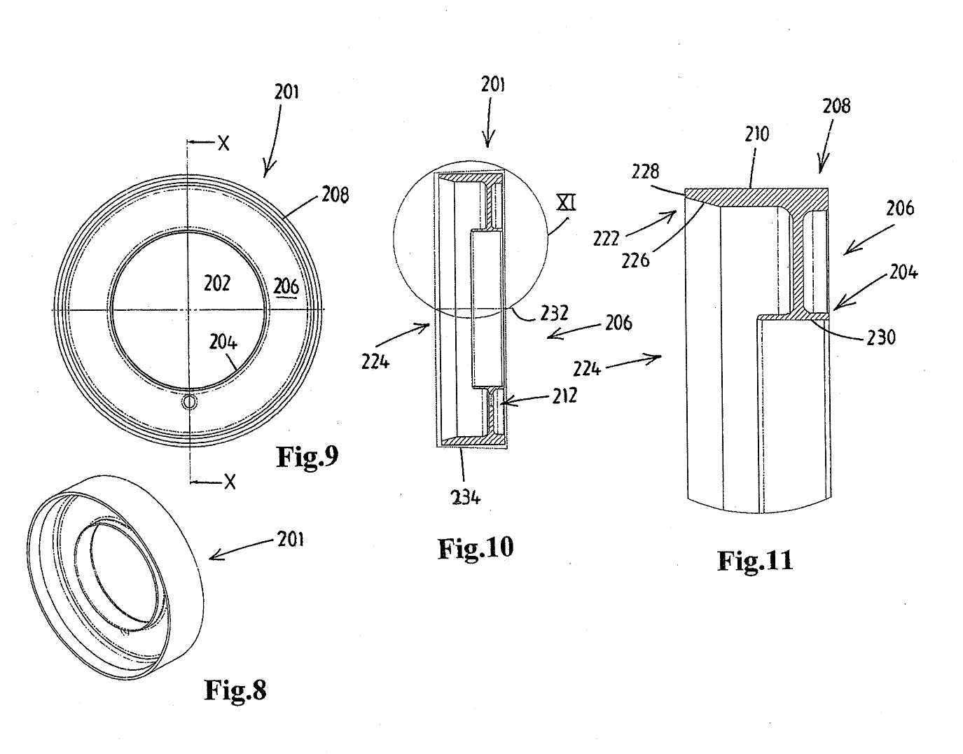

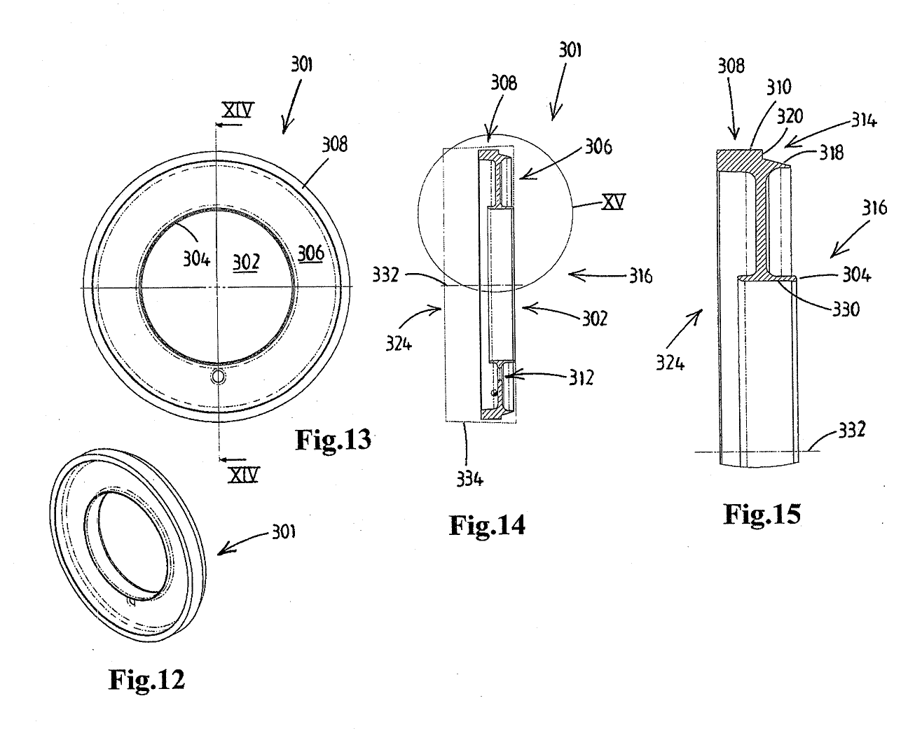

A starting disc 201 (FIGS. 8 to 11) comprises a central opening 202, a cylindrical base 204, a ring-shaped wall section 206 and an outside wall 208. The outside wall 208 comprises a cylindrical outside surface 210 that is formed through machining, in this case through surface removal by turning. The ring-shaped wall section 206 is provided with an air opening 212.

The starting disc 201 is formed from the cylindrical disc 1 through machining, in this case through the removal by turning of two contact surfaces. The starting disc 201 does not have a first gluing surface but has a second gluing surface 222 on its second axial end 224. The second gluing surface 222 comprises a conical wall section 226 and a ring-shaped wall section 228. The second gluing surface 222 is embodied to match the first gluing surface 114 of the intermediate disc 110.

The cylindrical base 204 is provided with a core gluing surface 230. On its first axial end 206, the cylindrical outside wall 208 as well as the cylindrical base 204 are machine to be flat, for this case in one and the same surface which rests perpendicular on the central axis 232 to form an end face. The second gluing surface 222 and the core gluing surface 230 are the two contact surfaces for this embodiment. FIG. 10 schematically shows the material which has been removed by turning to form, among other things, the contact surface with the aid of the original contour lines 234 of the cylindrical disc 1.

One end disc 301 is formed through machining, in this case surface removal by turning, from the cylindrical disc 1, where two contact surfaces are formed in the process. The end disc 301 comprises a central opening 302, a cylindrical base 304, a ring-shaped wall section 306 and a cylindrical outside wall 308. The cylindrical outside wall 308 comprises a cylindrical outside surface 310, that is formed through surface removal by turning from the cylindrical outside wall of the cylindrical disc 1. The ring-shaped wall section 306 is provided with an air opening 312. The end disc 301 is provided with a first contact surface in the form of a first gluing surface 304 on its first axial end 316. The first gluing surface 314 comprises a conical portion 318 and a ring-shaped portion 320. The first gluing surface 314 is designed to match the second gluing surface 122 of the intermediate disc 101. The end disc 301 is not provided with a second gluing surface on its second axial end 324. The cylindrical base 304, however, is provided with a second contact surface in the form of a cylindrical core gluing surface 330.

The cylindrical outside surface 308 is machined flat on its second axial end 324, to form an end surface which sits perpendicular on the central axis 332. FIG. 14 shows with the aid of a contour line 334 of the cylindrical disc 1 to what degree this cylindrical disc 1 has been machined down to form the end disc 301.

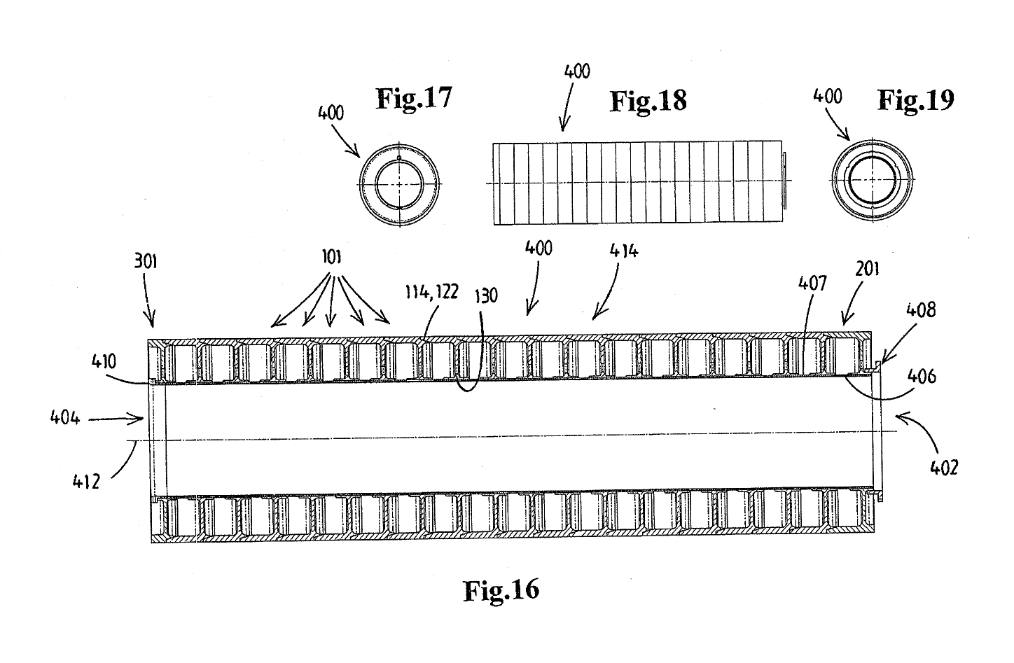

As shown in FIGS. 16 to 19, a printing cylinder sleeve 400 comprises a plurality, in this case 18, of intermediate discs 101 on a first axial end 402, a starting disc 201, as well as an end disc 301 on a second axial end 404. The printing cylinder sleeve 400 comprises furthermore a core in the form of a cylindrical inside tube 406 with a cylindrical outside surface 407, a pull ring 408 on its first axial end 402 and a register ring 410 on its second axial end 404. The pull ring 408 and the register ring 410 are fashioned from a stronger material than the discs which for this example is stainless steel. The pull ring 408 is provided with a ring that projects radially outward to make it easier to pull the printing cylinder sleeve 400 out of a printing press. The register ring 410 is provided with a recess to allow access to a register pin in the printing press. The inside tube 406 for this embodiment is formed with a fiber-glass reinforced intermediate layer and a compressible plastic outer layer on the outside, where the plastic outer layer for this embodiment is made of polyurethane.

Following the machining of the intermediate discs 101, the starting disc 201 and the end disc 301, the printing cylinder sleeve 400 is then processed further. In a first step, the register ring 410 is first fitted around a (non-depicted) temporary mandrel. The inside tube 406 is then fitted far enough around the same temporary mandrel, so that it comes to rest with one axial end against the register ring 410 and is stopped in the position shown in FIG. 16.

A certain amount of glue is provided on one section on the radial outside of the register ring 410 and on a section of the cylindrical outside surface 407 of the inside tube 406, near its axial end. Following this, the end disc 301 is pushed over the cylindrical outside surface 407 of the inside tube 406, so that its base 304 makes contact with the register ring 410. The pushing movement over the inside tube 406 ensures that the glue applied to the register ring 410 and the inside ring 406 is distributed between these surfaces and the core gluing surface 330 of the end disc 301. In this position, the core gluing surface 330 fits parallel against the cylindrical outside surface 407 of the inside tube 406. As a result, we can talk about a constant glue thickness and an end disc 301 that is arranged concentric to the central axis 412 of the printing cylinder sleeve.

A bead of glue is subsequently applied to the cylindrical outside surface 407 of the inside tube 406, at some distance to the end disc 301. At the same time, a glue bead is also applied to the first gluing surface 314 of the end disc 301. Following this, a first intermediate disc 101 is pushed over the inside tube 406, so that this intermediate disc with its second gluing surface 122 makes contact with the first gluing surface 314 of the end disc 301. The intermediate disc 101 is advantageously attached in a way that is explained in further detail later on with reference to FIG. 22. In the final position, the intermediate disc 101 is fitted concentrically around the inside tube 406, meaning the core gluing surface 130 is positioned parallel to the cylindrical outside surface 407 of the inside tube 406 and the core gluing surface 120 and the cylindrical outside surface 407 of the inside tube 406 face each other. The second gluing surface 122 of the intermediate disc 101 is arranged parallel to the first gluing surface 314 of the end disc 301. The second gluing surface 122 of the intermediate disc 101 is facing the first gluing surface 314 of the end disc 301. Owing to this parallel positioning, we have a glue layer with uniform thickness between the core gluing surface 330 and the inside tube 406 on the one hand and the first and second gluing surfaces 122, 314 on the other hand.

New glue beads are then applied to the inside tube 406 and the first gluing surface 114, in this case the intermediate disc 101, and an additional intermediate disc 101 is installed around the inside tube 406 in the manner as described in the above. This operation is repeated for all intermediate discs 101. During the installation and gluing together, the air openings 112, 212, 312 ensure that no excess pressure can develop between the starting disc, the spacing discs and the end disc 101, 201 and 301. This is designed to allow movement within the still non-hardened glue connections. The air openings 112, 212 and 312 furthermore ensure during the use that no pressure differences can develop in the spaces between the starting disc, the intermediate discs and the end disc 101, 201 and 301.

As the next to the last step during the assembly of the printing cylinder sleeve 401 and following the application of the glue beads, the starting disc 201 is pushed onto the inside tube 406. As the last assembly step, the pull ring 408 is glued in place in the starting disc 201. Following the hardening of the glue, the cylindrical outside surfaces 110, 210 and 310 are reworked which, for this embodiment, involves a following, precise trimming of the surface to generate a uniform diameter over the complete printing cylinder sleeve 400, thus creating a printing cylinder surface 414. In addition and in place of the surface removal by turning, the printing cylinder sleeve 400 can also be provided with an outer shell (not shown), for example by applying a layer of plastic around the cylindrical outside surfaces 110, 210 and 310. This has the advantage that damage to the printing cylinder surface can be repaired relatively easily by replacing the complete outer shell in question. A small variation with respect to diameter and thus also the printing length can furthermore be achieved with the aid of this outer plastic shell which can be applied with more or less thickness. As an additional processing step, a slot can be milled in the axial direction through the outer surfaces 110, 210 and 310 into the outside walls 108, 201 and 308. This slot is designed to accommodate the plate edges of a printing plate and/or a rubber printing plate.

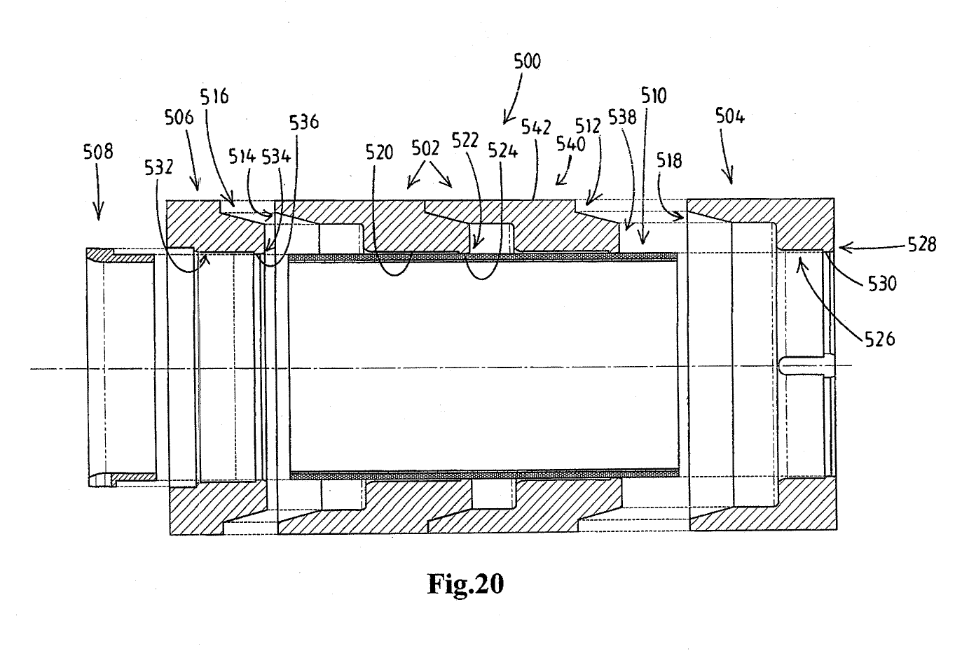

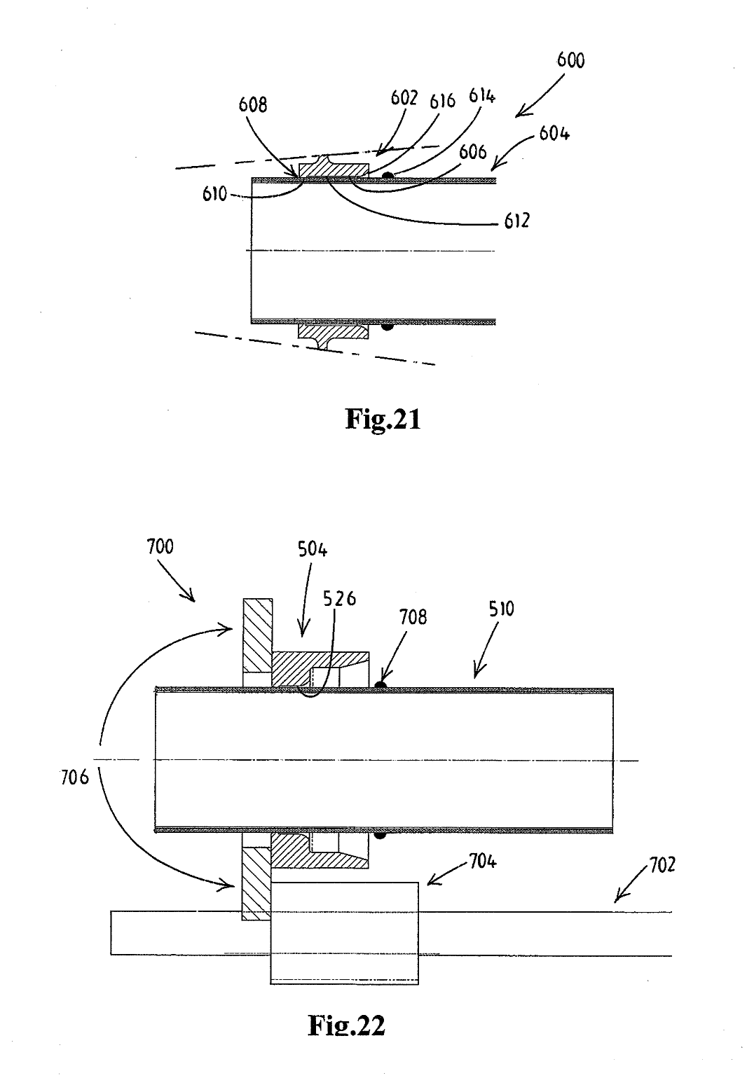

FIG. 20 shows a detail of a respective cross-section through an alternative printing cylinder sleeve 500. The printing cylinder sleeve 500 comprises a plurality of intermediate discs 502, where two intermediate discs 502 are shown for this simplified example. In reality, the embodiment should generally be provided with more than 20 intermediate discs. The printing cylinder sleeve 500 comprises furthermore a starting disc 504, an end disc 506, a register ring 508 and a core in the form of an inside tube 510. The intermediate discs 502 are respectively provided with a first gluing surface 512 and a second gluing surface 514. The end disc 506 comprises a first gluing surface 516 which is identical to the first gluing surface 512 of the intermediate disc 502. The starting disc 504 comprises a second gluing surface 518 which is identical to the second gluing surface 514 of the intermediate disc 502. The first 512, 516 and the second 514, 518 gluing surfaces fit together to complement each other. In the fully assembled state, the first gluing surfaces 512, 516 and the second gluing surfaces 514, 518 are intended to fit parallel against each other, so that a layer of glue with uniform thickness is positioned between them. The intermediate discs 502 also comprise a core gluing surface 520, as well as a stop edge 522 that is provided radially on the inside with a central surface 524. The function of the stop edge 522 is to be explained later on with the aid of the embodiment shown in FIGS. 21 and 22.

The starting disc 504 comprises a core gluing surface 526 as well as a stop edge 528 with a central surface 530. The end disc 506 comprises a core gluing surface 532 as well as a stop edge 534 with a central surface 536. The intermediate disc 502 comprises a cylindrical base 538 and a cylindrical outside wall 540. The cylindrical outside wall 540 has a cylindrical outside surface 542.

The intermediate discs 502 as well as the starting disc 504 and the end disc 506 of this embodiment are produced with the aid of machining, meaning removal by turning, from thick-walled pipe segments. This material forms a relatively advantageous starting material since it does not require the casting of a cylindrical disc in a single step. However, this embodiment is restricted by the maximum coating that can be applied to the wall thickness of standard pipes, thus providing fewer options for varying the diameter of printing cylinder sleeves and the wall thickness for the printing cylinder sleeves than is the case with the previous example. The forms and functions of the first and second gluing surfaces 512, 514 and the core gluing surface 520 coincide with those of the first intermediate discs 101 disclosed for the first embodiment. The functions of the outside wall and the base are also comparable to those described in the first embodiment, including the option of milling a lot into this wall. The second embodiment lacks a separate ring-shaped wall section because of its lower thickness.

FIG. 21 shows a portion of a cylindrical disc in the form of an intermediate disc, a starting disc or an end disc for a printing cylinder sleeve 600 to be assembled. The respective disc can furthermore be equated to one of the discs 101, 201, 301, 502, 504, 506 from one of the previous embodiments, even though parts are different here. The part shown herein comprises a cylindrical base 602, provided around a core in the form of an inside pipe 604. The inside pipe 604 for this embodiment consists of an intermediate layer of glass-fiber reinforced plastic and an outside layer of a compressible plastic material, for example polyurethane.

The cylindrical base 602 comprises a core gluing surface 606 and a stop edge 608 which is provided with a central surface 610. The core gluing surface 606 is located further outside in the radial direction by 0.1 mm than the central surface 610 of the stop edge 608. The inside pipe 604, the stop edge 608 and the core gluing surface 606 define a space 612 for accommodating a glue bead 614. The cylindrical base 602 is furthermore provided with a glue-intake surface 616 which extends from the core gluing surface 606 toward the outside. For this embodiment, the glue-intake surface is embodied to have a rounded shape.

During the assembly of the printing cylinder sleeve 600, the central surface 610 of the stop edge 608 ensures that the respective cylindrical disc is positioned concentric around the inside pipe 604. For this, the central surface 610 adjoins without play the outside surface of the inside pipe 604. Thanks to the plastic intake surface 616, the glue bead 614 moves into the space 612 for accommodating the glue if the cylindrical base 602 is pushed axially over the glue bead 614 (to the right as seen in FIG. 21). The glue intake surface 616 ensures that a relatively large amount of glue can be accommodated and will be distributed evenly. As a result, a cylindrical base 602 with relatively large axial dimensions can be supplied to a relatively large core gluing surface 606. The function of the cylindrical base, as shown with other types of embodiments, is to transfer force from a cylindrical disc to the inside pipe. It is therefore advantageous to be able to advance a cylindrical base with a relatively large core gluing surface.

FIG. 22 shows a tool 700 for attaching cylindrical discs, for the embodiment the starting disc 504 (see FIG. 20), around the inside pipe 510. The tool 700 is also intended for attaching other types of cylindrical discs and is furthermore suitable for attaching all starting, end, and intermediate discs described in the above. The tool 700 comprises a guide 702, a sliding carrier 704 and a sliding disc 706 that is connected to the sliding carrier 704. The inside tube 510 is arranged on an auxiliary mandrel that is not shown herein. The auxiliary mandrel and the tool 700 are fixedly connected during the use. With the aid of the tool 700, the starting disc 504 is displaced in a straight line over the inside pipe 510, thereby distributing the amount of glue 708 uniformly over the core gluing surface 526.

Diverse variants may be possible in addition to the embodiments shown and described herein. Thus, it may be possible to produce the cylindrical discs from other, relatively light-weight materials. It may be furthermore possible to fit the cylindrical discs around a different type of core or around a core of a different material. A printing cylinder may furthermore be embodied in place of a printing cylinder sleeve for supplying a solid core. The various aspects of this embodiment may have advantages, either in combination or also separately. The cylindrical base with the glue intake surface may thus be used advantageously with other types of cylindrical discs for a printing cylinder. According to one embodiment, cylindrical discs for a printing cylinder or a printing cylinder sleeve may also be provided with gluing surfaces, for example with one gluing surface or with a central gluing surface.

The cylindrical discs may be connected alternately with the aid of a connecting step, where no thermal energy is supplied to the cylindrical discs, thereby avoiding that the cylindrical discs are deformed by the thermal effect. For example, the cylindrical discs may be joined alternately with the aid of glue. For one or more of the glue connections, it may be possible to supply contact glue that is not filling in place of the filling glue. Alternatively, the cylindrical discs may also be joined with the aid of a mechanical connection, for example a screw connection. The aforementioned applies the required changes for the connection between the cylindrical discs and the core.

According to another embodiment, a basic cylindrical disc may be produced through press-forming it out of a thick-walled material. Owing to the machining step, it may not be necessary during the press-forming to produce precise gluing surfaces which can be bothersome, for example, when using larger wall thicknesses. The machining step furthermore may allow removing material at locations where this material is not needed from the point of view of the strength and where it is undesirable because of the weight, such that ring-shaped wall sections can be arranged thereon. To make available instead a comparatively thin wall thickness for a ring-shaped wall section directly, through press-forming, the cylindrical outside wall of necessity may also be thin, meaning it is no longer possible to work in a slot by milling.

According to another embodiment, each cylindrical disc may include a plurality of air openings. By inserting the plurality of air openings to be distributed symmetrical around the central axis of the cylindrical disc, the balance may be improved. The at least one air opening can also be inserted in a section other than the ring-shaped wall section. This may create an open gas connection between the one axial side of the cylindrical disc and the other axial side of the same cylindrical disc. It may be possible to integrate the function of the register ring into the end disc. In that case, the end disc may be provided with an opening for providing access to a register pin in the printing press and the printing cylinder or the printing cylinder sleeve may not be provided with a separate register ring.

The machining step may allow achieving a high shape accuracy of the important surfaces of the cylindrical disc, for example, the contact surfaces as well as the gluing surfaces and the core gluing surface. This high precision can be achieved while starting with a basic cylindrical disc which itself can already have high shape precision. Thus, a basic disc can be used which is formed by casting a molten metal in a single casting step or which is obtained as an intermediate segment from a standard pipe, as described in the above. Owing to the fact that a relatively imprecise basic disc can be used, the purchase costs may be relatively low. As a result of the machining step it may be furthermore possible to provide a relatively thick wall thickness where needed, for example on the outside wall of the printing cylinder, in connection with the desired rigidity and the cutting of a slot, as well as to have lower wall thicknesses, for example for the ring-shaped wall sections that are shown. An additional advantage of the higher wall thicknesses of the discs, as compared to the press-formed discs, is that they can be hardened easier with the aid of a thermal treatment.

In another embodiment, the starting and the end discs, as well as the intermediate discs, may be formed from the same basic cylindrical disc with the aid of a machining operation. In addition to and/or in place of the surface removal by turning, a machining operation of this type can also include, for example, the milling of ring-shaped wall sections to reduce their thickness, the cutting for producing a non-round central opening, or the drilling for producing the core gluing surface and/or the central surface in the central opening.

It will be understood that the above description of the present invention is susceptible to various modifications, changes and adaptations, and that the same are intended to be comprehended within the meaning and range of equivalents of the appended claims.

What is claimed is:

1. A method for producing a printing cylinder or a printing cylinder sleeve, comprising:
providing a plurality of cylindrical discs with an essentially cylindrical outside surface and respectively one central opening for positioning the cylindrical discs around a core;
machining the essentially cylindrical outside surfaces so that the cylindrical discs form a printing cylinder surface when mounted on the core;
prior to positioning the cylindrical discs around the core, machining at least one of the cylindrical discs to form at least one contact surface, wherein the at least one contact surface is machined precisely so that during the installation of the respective cylindrical disc around the core, the at least one contact surface comes to rest parallel against a complementary formed surface of an adjacent element of the printing cylinder or printing cylinder sleeve;
positioning the cylindrical discs around the core; and
alternately joining the cylindrical discs.

2. The method according to claim 1, wherein the step of machining at least one of the cylindrical discs to form at least one contact surface includes machining a first gluing surface on a first axial end of the at least one cylindrical disc.

3. The method according to claim 2, wherein the step of machining at least one of the cylindrical discs to form at least one contact surface includes machining a second gluing surface on an axial end of a different cylindrical disc to follow the one cylindrical disc, wherein during the positioning of the cylindrical discs, glue is applied to at least one of the first or second gluing surfaces and the first gluing surface and the second gluing surface are fitted parallel to face against each other.

4. The method according to claim 2, further comprising:
machining a second gluing surface on a second axial end of the at least one cylindrical surface.

5. The method according to claim 1, wherein the machining at least one of the cylindrical discs to form at least one contact surface comprises machining only one axial end of the at least one cylindrical disc to form a gluing surface, and the step of positioning includes positioning the at least one cylindrical disc on an axial end of the printing cylinder sleeve.

6. The method according to claim 1, wherein the at least one cylindrical disc further includes a stop edge located inside the central opening,
wherein the step of machining at least one of the cylindrical discs to form at least one contact surface comprises machining a central surface on a radial inside of the stop edge of the at least one cylindrical disc, and
wherein the step of positioning includes positioning the central surface to come to rest, without play, against the core.

7. The method according to claim 6,
wherein the at least one cylindrical disc includes a core gluing surface in the central opening, which is delimited on a first axial end of the at least one cylindrical disc, and
wherein the core gluing surface extends radially toward the outside of the at least one cylindrical disc relative to the central surface.

8. The method according to claim 7, wherein the core gluing surface is delimited by the stop edge on the first axial end.

9. The method according to claim 8, wherein the core gluing surface includes a glue intake surface on a second axial end which faces away from the first axial end, wherein the glue intake surface extends radially outward and axially away from the core gluing surface and the method further comprises:
applying filling glue to the core; and
pushing the at least one cylindrical disc over the filling glue applied to the core, wherein the at least one cylindrical disc receives the filling glue through the glue intake surface and moves it into a space defined by the core gluing surface, the stop edge and the core.

10. The method according to claim 1, wherein the step of machining at least one of the cylindrical discs to form at least one contact surface includes machining a core gluing surface inside the central opening of the at least one cylindrical disc, wherein the core gluing surface is arranged parallel to an outside surface of the core when positioned on the core, as seen in the radial direction.

11. The method according to claim 1, wherein the steps of machining comprise surface removal by at least one of turning, milling, drilling and cutting.

12. The method according to claim 1, wherein the step of providing a plurality of cylindrical discs includes:
casting a viscous material in at least one mold;
allowing the viscous material to solidify; and
removing the solidified viscous material from the at least one mold to produce a respective one of the plurality of cylindrical discs.

13. The method according to claim 12, wherein the viscous material comprises a molten metal.

16. The method according to claim 1, wherein the step of providing the plurality of cylindrical discs includes producing the plurality of cylindrical discs from a metal pipe.

17. The method according to claim 1, wherein the step of machining the essentially cylindrical outside surface to form the printing cylinder surface comprises a total removal by turning of the essentially cylindrical outside surfaces, after positioning the cylindrical discs around the core and coupling the cylindrical discs to one another.

18. The method according to claim 1, wherein the step of machining the essentially cylindrical outside surfaces to form the printing cylinder surface further includes providing a gap in the printing cylinder surface in an axial direction, wherein the gap is disposed to accommodate edges of a printing plate or a rubber printing plate.

19. A printing cylinder or a printing cylinder sleeve produced according to the method of claim 1.
